(19) United States
(12) Patent Application Publication
(10) Pub. No.: US 2010/0095483 A1
(43) Pub. Date: Apr. 22, 2010

(54) BIASED HINGE FOR EQUIPOISING SUPPORT EQUIPMENT

(76) Inventor: Garrett W. Brown, Philadelphia, PA (US)

Correspondence Address: SCHNADER HARRISON SEGAL & LEWIS, LLP, 1600 MARKET STREET, SUITE 3600, PHILADELPHIA, PA, 19103, US

(21) Appl. No.: 12/530,023

(22) PCT Filed: Mar. 11, 2008
(86) PCT No.: PCT/US08/56511

§ 371 Date: Oct. 29, 2009

Related U.S. Application Data
(63) Continuation of application No. 61/019,350, filed on Jan. 7, 2008.
(60) Provisional application No. 60/894,571, filed on Mar. 13, 2007.

(51) Int. Cl. E05F 1/08; E05D 5/00

(52) U.S. Cl. 16/277; 16/221

(57) ABSTRACT

A hinge apparatus and a method of biasing a hinge are disclosed having a hinge body, at least one end block attached to the hinge body and pivotal therewith around an axis, and a biasing component attached to the hinge body to selectively influence the resting angle of the hinge body with respect to the first end block.

This application is based on, and claims priority to, U.S. provisional application Ser. No. 60/894,571, filed Mar. 13, 2007, and 61/019,350, filed Jan. 7, 2008, both entitled Biased Hinge for Equipoising Support Equipment.

### BACKGROUND OF THE INVENTION

Stabilizing equipment support devices have been employed in the motion picture and video industry since 1974 to permit hand-held camera operators to produce stable ambulatory images. Applicant's U.S. patent, Re-issue No. 32,213, described such an apparatus, marketed under the trademark “Steadicam®” which relies on a pair of spring-powered parallelogram arms to isolate and support the gimbaled mass of the camera equipment. The use of Steadicam® effectively revolutionized the movie and television production and earned an Academy Award in 1978. Applicant's subsequent U.S. Pat. Nos. 4,394,075, and 5,360,196, and pending patent application Ser. No. 11/403,731, describe increasingly sophisticated spring-loaded parallelogram arm pairs that are interconnected by hinges acting around vertical axes. Similar hinges interconnect the arms to the operator's semi-rigid harness. Applicant's current support arms permit an operator to position extremely heavy payloads in space with mere ounces of force and move them anywhere within reach of his or her own arms with fingertip precision.

Problems arise, however, when the sum of the hinge tolerances and the various parallelogram link bearing tolerances combine to permit the arm to increasingly ‘sag’ (as its hinge pins—spaced from the mount out to the payload—progressively depart from vertical) when the camera is held out further and further away from the operator. Close tolerances and rigid materials have become essential in the construction of these arms, but some ‘sag’ is inevitable, and operators have learned to compensate by slightly leaning back away from the camera during these arm extensions, to bias the camera payload so that it stays in place and does not continue to fall away.

Since the beginning of Steadicam® usage, ‘hard-mounted’ applications have occasionally been employed. A ‘hard-mounted’ arm is mounted directly to a fixed support, such as a portion of a camera car or camera dolly, so that the operator does not have to bear the load of the equipment, yet still provide the stabilizing effect of the gimbal mount and arm suspension to tune out the bumps as the vehicle progresses.

In these cases, current designs provide no remedy for ‘sag’ as the arm extends and the operator is required to continually hold back the payload with his or her other hand. This has been a serviceable arrangement for camera work, but will be a more significant problem for other applications of the stabilizing equipment. These arms are now projected to become an important element in reducing workplace fatigue and injuries caused by the repetitive lifting and deploying of heavy tools and equipment for industrial applications. These applications are likely to be ‘hard-mounted’ in most cases, and therefore a means is required to assist in the natural ‘centering’ of these arms so that they do not tend to fall away from the ideal location of use, if inadvertently displaced either inwardly or outwardly.

Industrial users for example, likely will not necessarily have a free hand to assist in keeping the payload where it is needed laterally, and so a means is required to perform that function.

Illustrative embodiments of the invention are directed to biasing means that impel the arm hinges (between the individual parallelograms, between the arm and the hard-mount or both) to seek the desired angular relationship with the parallelogram segments and with the mounting equipment, so that the hinges ‘self-center’ the arm components to seek the ideal working position for the payload.

### SUMMARY OF THE INVENTION

Exemplary embodiments of the invention bias hinges that interconnect equipment-supporting parallelogram arm segments around vertical axes, to seek selected angular relationships between the arm segments and/or with their mounting means.

Illustrative embodiments of the invention provide a biasing force that is automatically substantially proportional to the amount of weight born by the support arms, so that the biasing force is appropriate to provide a positioning impetus that counters the ‘sagging’ impetus produced by the accumulation of bearing tolerances and component twisting. This allows the action of the biased hinges to be transparent to the operator, who may thus freely move the payload laterally without consciously applying a compensating force. The position to which the apparatus is biased can be a center position or other position, depending on the structure of biasing component used.

Illustrative embodiments of the invention may also provide a biasing force system that can be contoured to place one or more ‘sweet spots’ of bias at such hinge angles as are selected to be favorable for accomplishing the desired work operations. Embodiments of invention may also provide a simple and inexpensive biasing force that produces constant, ‘anti-sag’ forces for payloads that do not vary in weight.

Illustrative embodiments of the invention variously offset selected resilient-means attachment points in order to separately bias arm links with respect to opposite ends of the central hinge.

In a further illustrative Embodiment of the invention, locking means is provided to selectively immobilize the angular relationship between hinges and equipoising arm segments.

Various illustrative embodiments of the invention provide a biasing mechanism that acts upon the angular relationship between the vertical-axis hinges between equipoising arm segments and/or between the equipoising arm structure and its ‘hard-mount’ equipment. These biasing mechanisms can include arcuate ‘hill-and-valley’ cam surfaces, consisting of one or more hills and valleys, and associated tapered cam-following rollers; or resilient means attached between hinged components, locations of which may be offset from the hinge pivot axes in various directions, in order to selectively impel the hinges into desirable angular relationships with hinged components, such as equipment-supporting parallelogram arm segments.

### DESCRIPTION OF THE DRAWINGS

For further detail regarding the support arm biasing hinges produced in accordance with illustrative embodiments of the invention, reference is made to the detailed description provided below, in conjunction with the following illustrations:

FIG. 1 is an exploded assembly diagram of a double-ended centering hinge according to an illustrative embodiment of the invention.

FIG. 2 is an assembled double-acting hinge transparently showing cam-driven centering components at both ends according to an illustrative embodiment of the invention.

FIG. 3 is a side cut-away view of a double-acting, self-centering hinge assembly according to an illustrative embodiment of the invention.

FIG. 4 is a side view showing a spring-loaded threaded locking pin to immobilize either end of a double-acting centering hinge according to an illustrative embodiment of the invention.

FIG. 5 is a diagrammatic top view of another illustrative embodiment of the invention using a resilient means to bias the centering hinge to the selected angular position.

FIG. 6 is a diagrammatic top view of the FIG. 5 embodiment showing the hinge forced into an angular position that further stretches the resilient means.

FIG. 7 shows a diagrammatic view of a force-exerting triangle as the hinge deploys straight out as in FIG. 6.

FIG. 8 depicts a diagrammatic view of a force-exerting triangle as the hinge deploys off to one side as in FIG. 5, according to an illustrative embodiment of the invention.

FIG. 9 is an illustrative support arm that can be used with an inventive hinge according to an illustrative embodiment of the invention.

FIG. 10 is a side elevation of a hinge interconnecting two arm segments illustrating two different resilient-means attachment geometries according to an illustrative embodiment of the invention.

FIG. 11 is a view of the underside of the hinge assembly of FIG. 10 detailing the ‘over-centers’ resilient-means attachment geometry according to an illustrative embodiment of the invention.

FIG. 12 is a top elevation showing a spring termination adjusting disc and selected spring position.

FIG. 13 illustrates spring deflection with parallelogram arm segment rotation according to an illustrative embodiment of the invention.

FIG. 14 illustrates spring deflection with parallelogram arm segment at the opposite extreme of rotation, as compared to FIG. 13, according to an illustrative embodiment of the invention.

FIG. 15 illustrates the effect of two differently selected and adjusted hinge-side spring attachment offsets to produce separately desirable end-block to hinge biases according to an illustrative embodiment of the invention.

FIG. 16 illustrates the effect of combining a hinge-side offset axle with an over-centers offset axel to produce end-block to hinge biases that can be oriented in either a ‘right-handed’ or left-handed' configuration according to an illustrative embodiment of the invention.

### DETAILED DESCRIPTION OF THE INVENTION

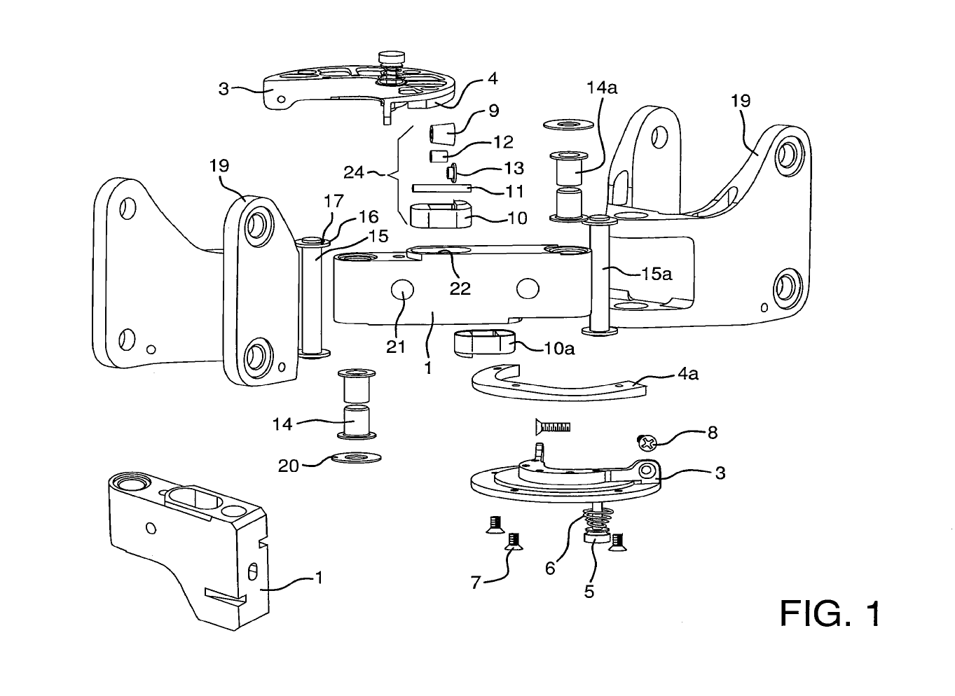

FIG. 1 shows an exploded assembly diagram of a double-ended, centering-hinge according to an illustrative embodiment of the invention. Hinge link 1 pivots between left and right hand end blocks 19 on pins 15 and 15a. Cam roller assembly 24 (comprising cam roller 9, roller block 10, axle 11, sleeve bearing 12, and flange bearing 13) is inserted in well 22 and arcuate cam plate 4 is attached to cam mounting plate 3, which is connected to end block 19. Cam plate 4 is thus in contact with cam roller 9 and as the hinge deploys angularly around pin 15, the hills and valleys on cam plate 4 ride up and down on cam roller 9 and cause end block 19 to correspondingly rise and fall. Flanged bearings 14 and 14a, preferably Teflon® serve to reduce friction and permit the end blocks to be easily displaced vertically on pin 15 by the cam action as the hinge swings around the end block. In this embodiment, the payload of the equipoising support arm is transferred by end block 19 through cam plate 4, which is in contact with roller 9. The weight is thus supported by hinge link 1 and in turn a second cam roller (not shown within roller block 10a) on the underside of hinge 1 rests on cam plate 4a, which likewise causes hinge 1 to rise and fall as the hinge angle relative to end block 19 is varied. This arrangement has the virtue of providing cam induced biasing action, which can be substantially proportional to the weight born by the support apparatus, and which seeks the ‘valleys’ in the cam plate.

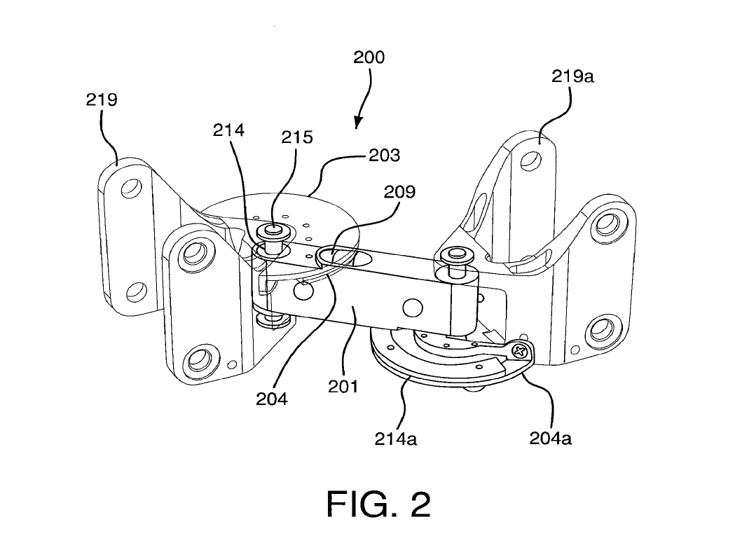

FIG. 2 shows double-acting hinge assembly 200, transparently showing cam-driven centering components at both ends according to an illustrative embodiment of the invention. Cam mounting plate 203 is attached to end block 219. As hinge 201 swings around pin 215, cam plate 204 (hidden beneath cam mounting plate 203) rides on cam roller 209 so that the cam plate's hills and valleys cause end block 219 to rise and fall, causing pin 215 to be displaced vertically within flange bearings 214. Gravity, therefore will tend to bias cam plate 204 against roller 209 and impel hinge 201 to seek the thinner ‘valleys’ versus the thicker ‘hills’ of the cam. Therefore, depending on the designed position of valleys and hills along the arcuate cam plate, the support arm segments (not shown) can be biased to desired angular orientations relative to hinge 201.

End block 219a and the analogous cam components on the underside of hinge 201, such as cam plate 204a and flange bearings 214a as shown, can likewise be biased to complementary positions so that the orientation of the support arm segments (not show) will tend to maintain the payload in the desired location.

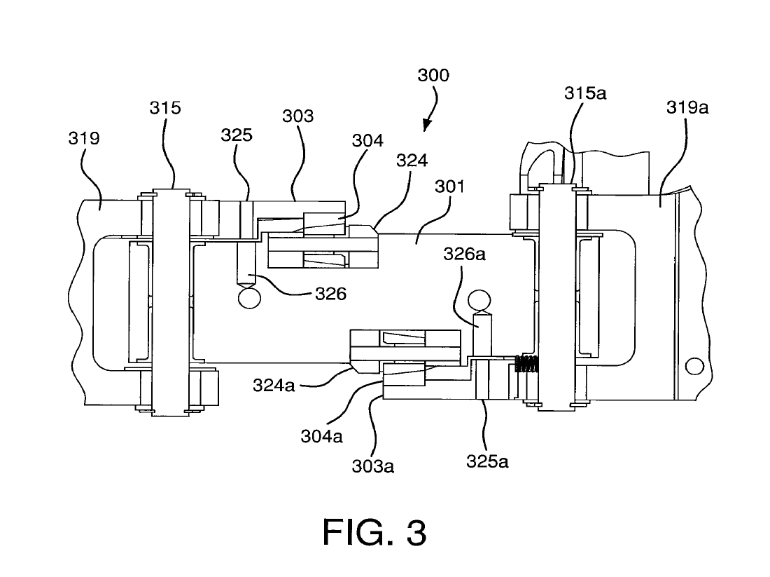

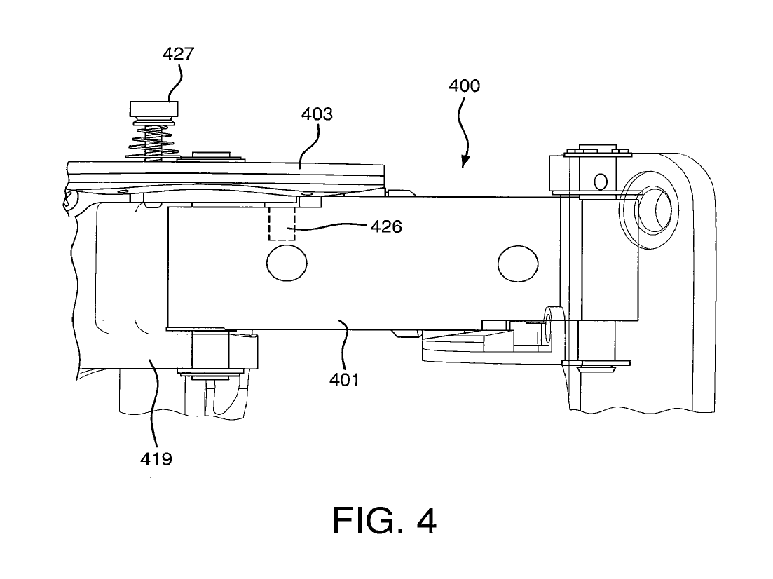

FIG. 3 is a cut-away side view of double-acting, self-centering hinge assembly 300 according to an illustrative embodiment of the invention. Hinge 301 pivotably interconnects end blocks 319 and 319a by pins 315 and 315a. Cam roller assemblies 324 and 324a are preferably imbedded in respective wells in hinge 301. Cam mounting plates 303 and 303a are attached to end blocks 319 and 319a, respectively, and support interchangeable arcuate cam plates 304 and 304a. The interaction of cam rollers and selectively sculpted hills and valleys on the cam plates tends to bias the relative end block to hinge orientations that facilitate the deployment of the support arm payload (not shown). The cam and cam roller interaction can be based primarily on gravity or the two components can be forcibly in contact with one another. A spring loaded, threaded locking pin (not shown in FIG. 3, but an example of which is shown as locking pin 427 in FIG. 4.), can be inserted in a selected hole, among a selection of holes such as 325 or 325a to engage locking pin 326 or 326a in hinge 301 in order to angularly immobilize either side of the double-acting hinge, to prevent compound relative motion and cause simple pivotable motion between the opposite end block and hinge 301. Both sides can also be immobilized if desired.

FIG. 4 is a partial side view of biasing hinge assembly 400, showing a spring-loaded threaded locking pin to immobilize either end of a double-acting biasing hinge according to an illustrative embodiment of the invention. Locking pin 427 is inserted in one of a series of holes (only one of which is shown) in cam mounting plate 403, so that when the locking hole 426 in hinge 401 lines up with locking pin 427 the relative angular positions of end block 419 and hinge 401 can be fixed. Preferably the series of holes are disposed in an arced configuration.

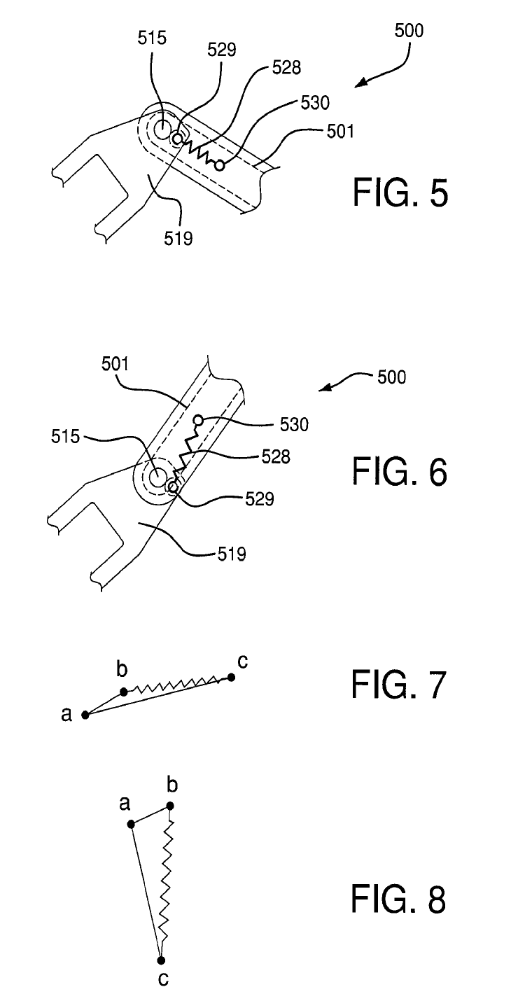

FIG. 5 is a diagrammatic top view of a hinge mechanism 500 according to an illustrative embodiment of the invention, which employs resilient means 528 to bias centering hinge 501 to a selected position. Hinge 501 pivots about pin 515. Offset pivot pin 529 is connected to hinge pivot pin 530 by resilient means 528. Hinge 501 is shown in the position that roughly yields the shortest distance between pins 529 and 530, which, in the absence of opposing forces, will be the default position of hinge 501 relative to end block 519.

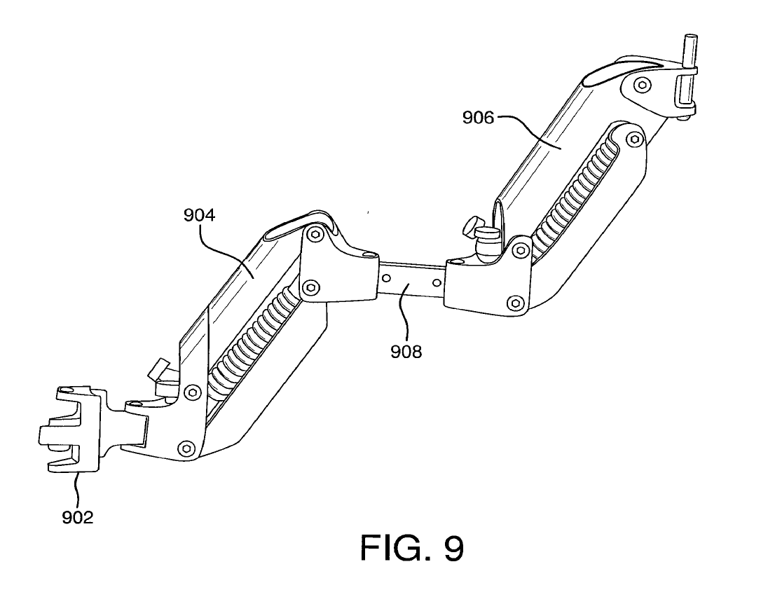

FIG. 6 is a diagrammatic top view of hinge mechanism 500 according to a further illustrative embodiment of the invention, showing a hinge 501 forced into an angular position that further stretches resilient means 528.

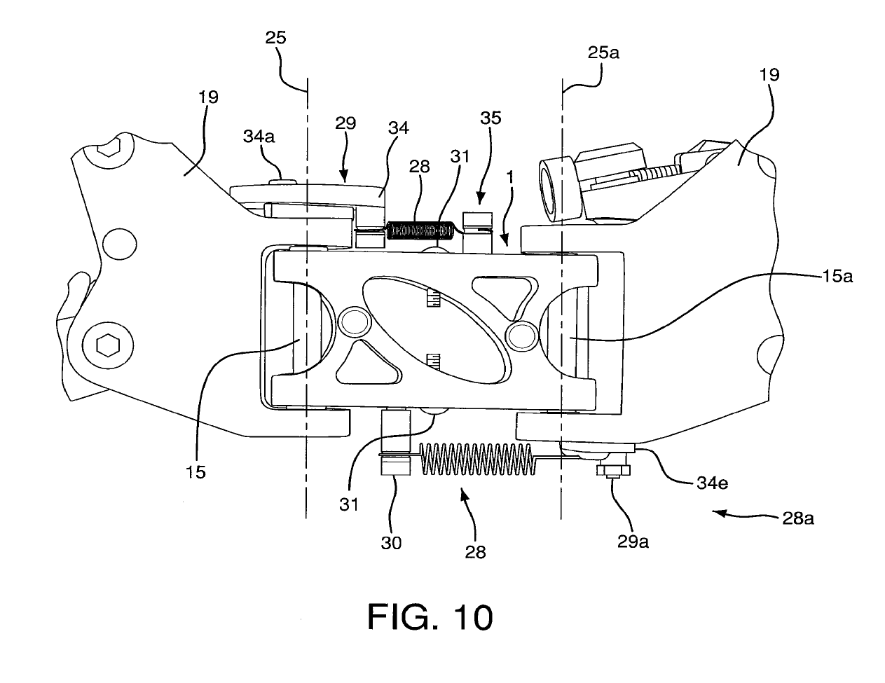

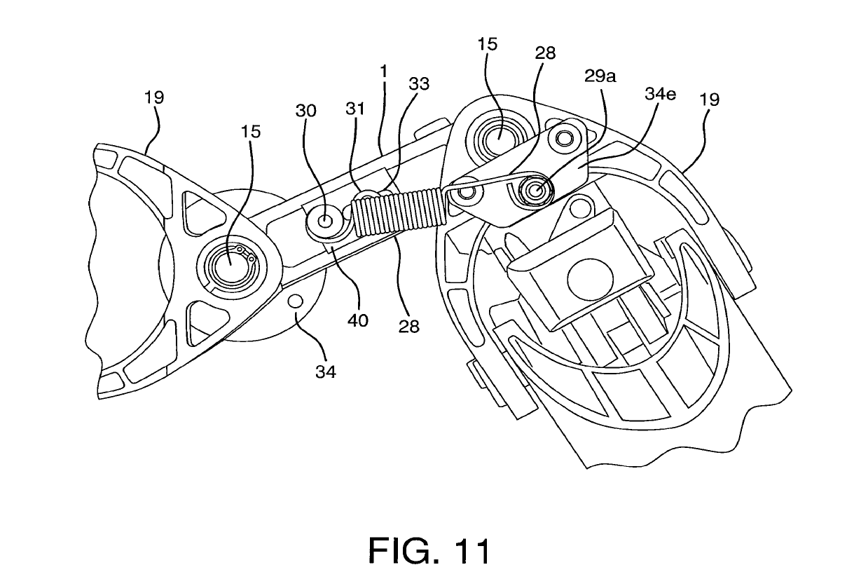

FIG. 7 and FIG. 8 show diagrammatic views of two illustrative force-exerting triangles as the hinge deploys straight out, as in FIG. 6. FIG. 8 depicts a force triangle as the hinge is off to one side, as in FIG. 5. Note that distance bc in FIG. 7 is clearly shorter than distance bc in FIG. 8. This explains how the resilient means of this embodiment of the present invention can be used to bias the hinge of FIG. 5 to the position shown.

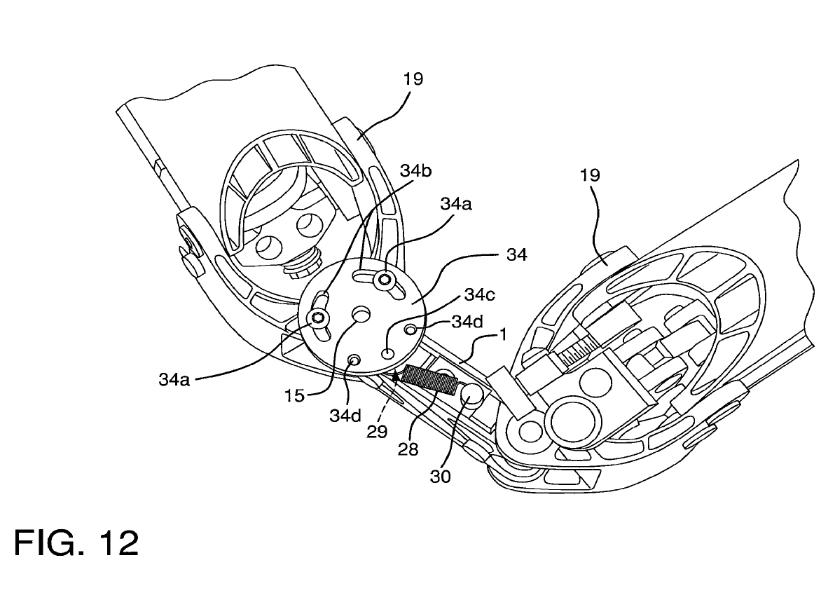

FIG. 9 depicts an illustrative support arm that can be used with an inventive hinge. The hinge can link the support arm to a base for example at location 902. It can also join the two arm segments 904, 906 at junction 908.

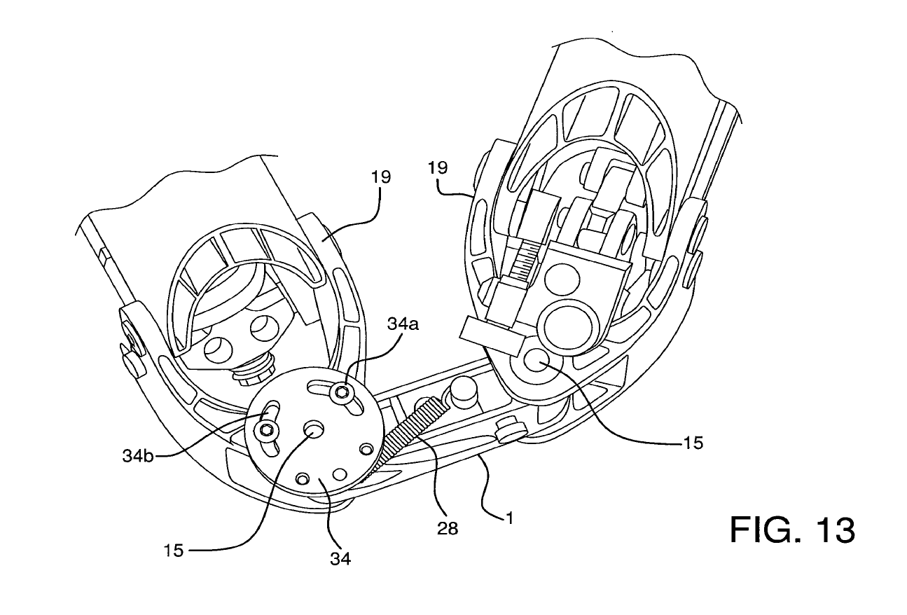

FIG. 10 is a side elevation of hinge 1 interconnecting two arm segments (not completely shown) by means of two different resilient-means attachment geometries. End blocks 19 are attached to parallelogram support arm segments (not shown) and are interconnected to hinge 1 by means of hinge pins 15, 15a so that arm segments pivot respectively on hinge pivot centerlines 25, 25a. Spring termination disc 34 is attached to end block 19 by locking screws 34a and mounts offset spring attachment axle 29 on the hinge-side of pivot centerline 25 so that spring attachment axle 29 changes distance from hinge-mounted spring attachment axle 35 as end block 19 rotates relative to hinge 1. As shown, resilient means 28, here illustrated as a spring with extended attachment hook 28a) serves to bias end block 19 to seek the orientation that provides the shortest spring length—as shown with end block 19 lined up with hinge 1. Beneath hinge 1, axle 29a overcenters offset spring attachment on the opposite side of pivot line 25a (away from the hinge) and therefore spring 28, attached to hinge 1 by means of axle 30 will tend to bias end block 19 to seek orientations 90 degrees to either side of hinge 1. The combination of these two spring attachment geometries biases end blocks 19 to a 90 degree relative orientation, which can forcibly be re-oriented to be stable on either side—for ‘right-handed’ or left-handed' payload supported operations.

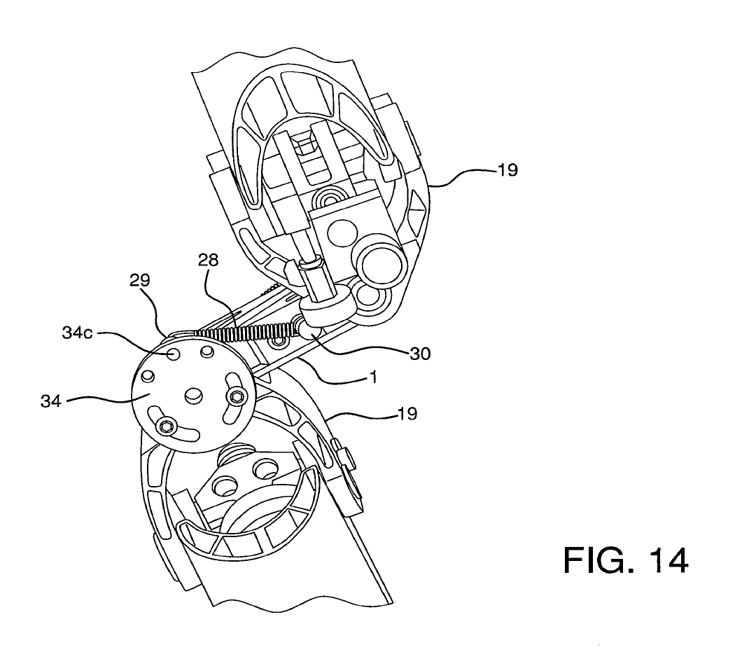

FIG. 11 is a detail of the underside of hinge 1 as illustrated in FIG. 10 showing the ‘over-centers’ resilient-means attachment geometry according to an illustrative embodiment of the invention. Overcenters attachment axle 29a, mounted on mounting plate 34e attached to end block 19 is displaced toward end block 19 from hinge pin centerline 25a (see FIG. 10), and is thus offset away from hinge 1. Resilient means 28 (shown here as a spring) operatively connects hinge-mounted axle 30 with over-centers axle 29a and thus biases end block 19 and its attached parallelogram support arm (not shown) to orientations that are 90 degrees on either side of the centerline of hinge 1. A tension adjusting mechanism can also be provided, such as spring tension plate 40. A spring tension adjusting plate slide 40 within a recess in the top of hinge 1 by means of slot 33 and locking screw 31 to provide a range of spring tensions to bias the various degrees of arm ‘sag’ caused by payloads of differing weight.

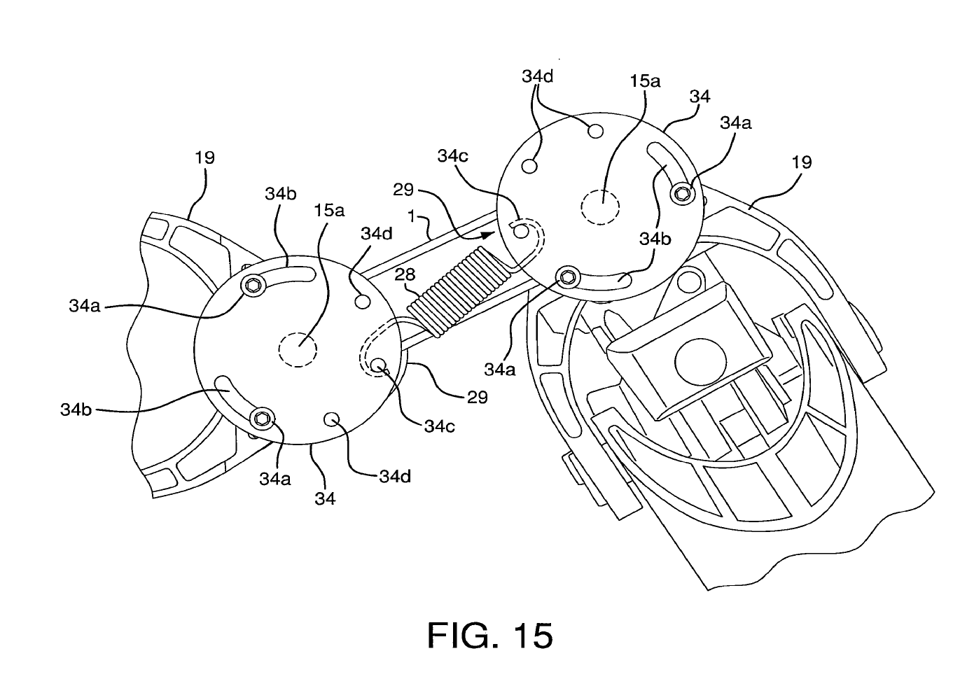

FIG. 12 is a top elevation showing spring termination adjusting disc 34 and selectable spring axle positions 34d, according to an illustrative embodiment of the invention. Spring 28 resiliently connects hinge-mounted offset spring axle 30 with offset axle 29 mounted on disc 34 at selected location 34c, (positionally adjusted by means of slots 34a and locking screws 34b), in order to bias end block 19 in a substantially straight line orientation with respect to hinge 1 in an illustrative embodiment of the invention. FIG. 12 shows the selectable spring axle positions 34d being disposed in an arc around spring termination disc 34. It is noted that other geometries of selectable positions are within the spirit and scope of the invention and can provide different biasing configurations. Further, although the termination disc is shown with hinge pin 15 in the center of the termination disc, it can be offset, to create desired biasing effects and variations in spring tensions.

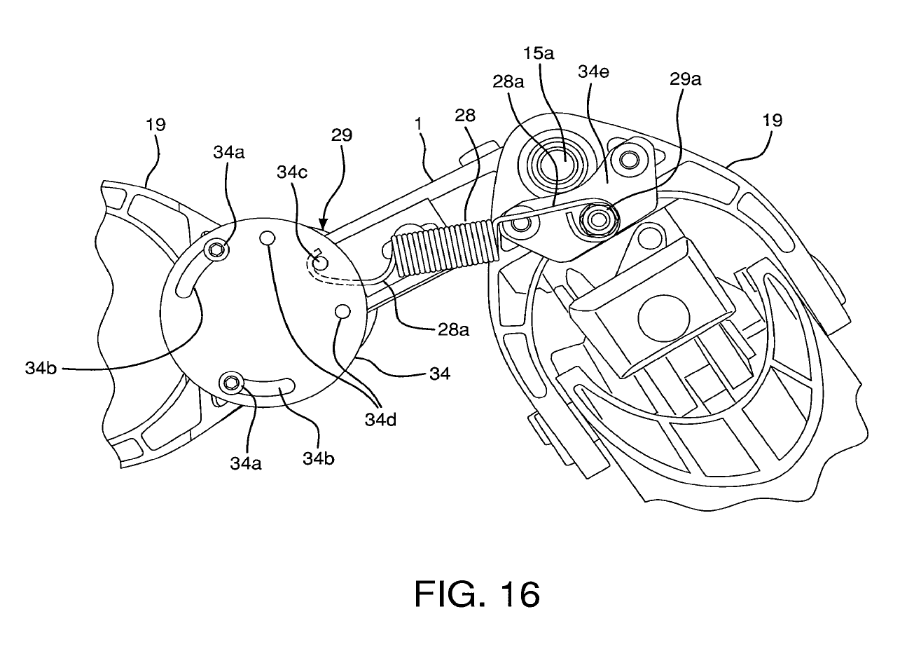

FIG. 13 illustrates forcible deflection of spring 28 caused by rotation of arm end block 19 and attached spring termination adjustment disc 34 in an illustrative embodiment of the invention. Since hinge pivot pins 15 (one partly hidden) are maintained in a vertical position, relatively small biasing forces around hinge pivot pin centerlines will impel end block 19 to return to (in this example) a substantially straight-line orientation with respect to hinge 1.

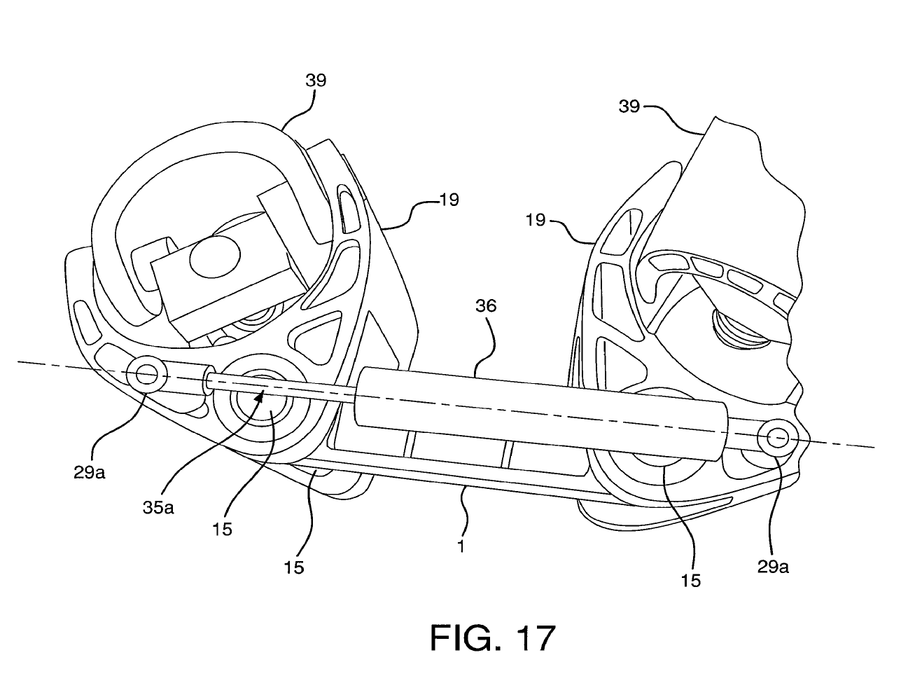

FIG. 14 illustrates end block 19 and attached spring termination disc 34 forcibly rotated to the opposite angular extreme with respect to hinge 1, as compared to the position depicted in FIG. 13, so that spring 28 resiliently connects offset axle at location 34c with hinge-mounted axle 30, oppositely biased, as compared to FIG. 13, to return to a linear orientation with hinge 1.

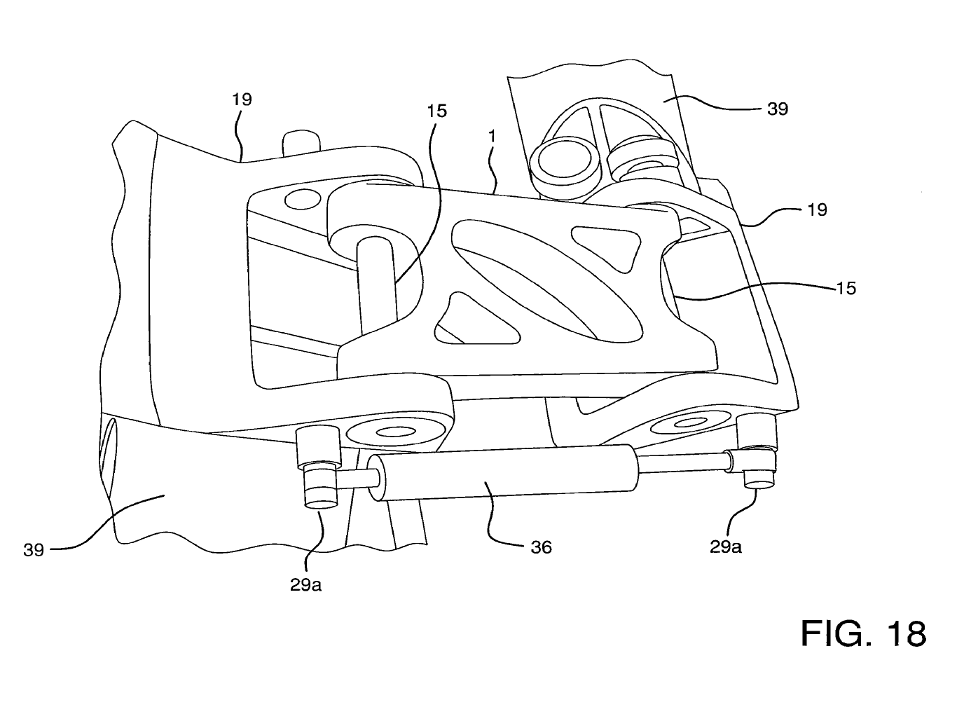

FIG. 15 illustrates the effect of two differently selected and adjusted hinge-side spring attachment offset locations 34c to produce different respective biases between end-blocks 19 and hinge 1, according to an illustrative embodiment of the invention. A single tension spring 28, acts directly between offset axles 29 (not visible) to resiliently pull them toward each other and thus orient their respectively attached end blocks 19 to seek a desired angular relationship. In this example, respective spring termination discs 34 are rotated by means of slots 34b and locking screws 34a to different orientations, and different hinge-side offset positions are chosen for spring axles 29 (not shown) from among the alternate axle locations 34d. The illustrated choices and respective adjustments tend to maintain the relative orientation of end blocks 19 illustrated in this example.

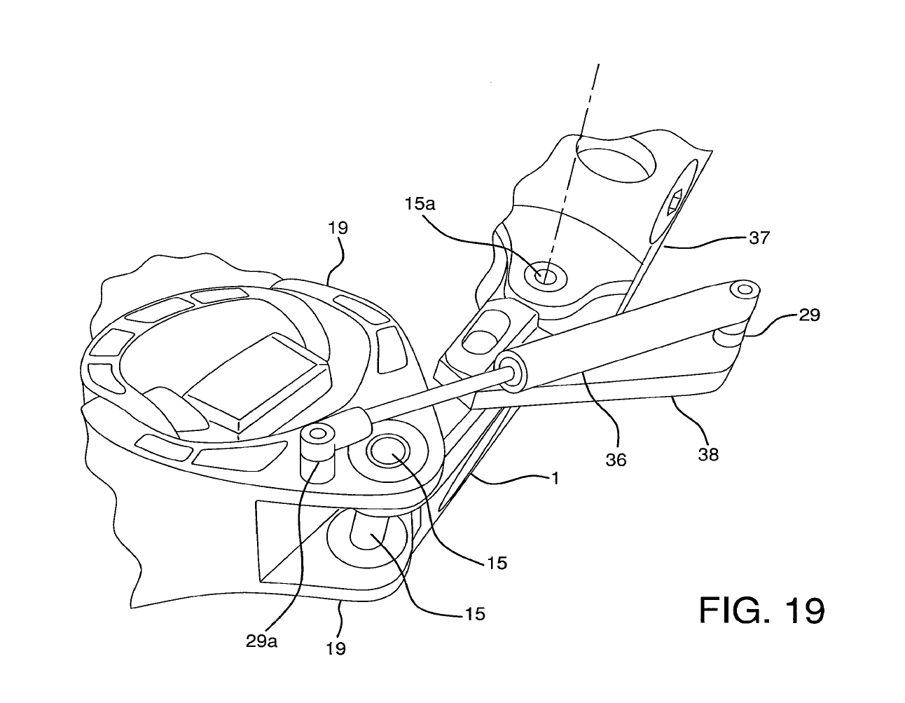

FIG. 16 Illustrates the effect of combining hinge-side offset axle 29d (hidden) with over-centers offset axle 29a to produce bias end-blocks 19 to hinge 1 in a manner that can be oriented in either a ‘right-handed’ or ‘left-handed’ configuration. A single resilient means (spring 28 with extended attachment hooks 28a, for example) resiliently connects hinge-side spring offset attachment location 34c with overcenters offset spring axle 29a (attached to end block 19 by means of mounting plate 34e), such that both end blocks 19 are simultaneously biased to the illustrated 90 degree relative orientation. A feature of this spring attachment geometry is that end block 19 can be forcibly re-oriented 180 degrees, causing the spring to ‘cross centers’ by passing over pivot centerline 15a and thus bias end block 19 to retain the opposite orientation with respect to hinge 1.

FIG. 17 is an inverted bottom-elevation of a central arm hinge 1 showing a compression gas-spring 36 attached between axles 29a which are respectively offset from the hinge pivot locations 15 on the respective arm segment end-blocks 19 to bias them to seek the angular relationships shown. The illustrated offset positions for axles 29a, will therefore be mutually displaced by the action of gas spring 36, to the farthest-apart positions attainable, which, if not restricted by mechanical interferences, and if displaced relatively symmetrically, will achieve equilibrium and come to rest with the gas spring centerline 36 roughly co-planar with the hinge body 1. This will cause end-blocks 19 to more or less strongly maintain their relative angular orientation, depending on the spring rate of gas spring 36 and on the magnitude and direction of the offset distances between axles 29a and hinge pivots 15.

FIG. 18 is a right-side-up side-elevation of resilient means 36 of FIG. 17 further illustrating the relationship between the locations of offset axles 29a and central hinge 1 between arm end blocks 19.

FIG. 19 is an upside-down isometric bottom-elevation of a terminal arm hinge 1 showing compression gas spring 36 attached between overcenters axle 29a on the arm-segment end-block as offset from the hinge pivot position, and opposite spring axle position 29 fixedly associated with hinge body 1, but offset on mounting bracket 38. As shown, axle 29a is forcibly pushed apart from axle 29 by action of compression-spring 36, such that end block 19 assumes the approximate angular position shown with respect to the plane of hinge body 1. As illustrated, the relative orientation of hinge body 1 and main arm mounting bracket 37 are not influenced by the action of gas spring 36 because axle 29 is shown fixedly attached to and angularly associated with hinge body 1, which may, in this embodiment, swing freely around hinge pivot pin centerline 15a.

The gas spring can also be employed by attaching a first end of the gas spring to a first end block, offset from the axis of rotation of the hinge body with respect to the end block, and attaching the other end of the gas spring to a termination point on the hinge body. This biases the end block with respect to the hinge body. Having the gas spring attached to points at each of the end blocks, as opposed to on the hinge body biases the end blocks with respect to the hinge body, but also with respect to each other. To bias two end blocks separately, a gas spring can be employed for one end block on one side of the apparatus and a second gas spring can be employed for the second end block on the other side of the apparatus. This holds true for all biasing systems described herein. Different types of biasing systems can also be used at each end of the hinge body.

It is also noted that offset brackets can be used in all cases to position the termination point of a biasing component at a location not directly on the hinge body or end block.

The invention further includes a method of supporting equipment using embodiments of the equipment support system described herein and their equivalents.

The invention in its broadest sense can be described as a hinge apparatus comprising, a hinge body, a first end block attached to a first end of the hinge body and pivotal therewith around a first axis, and having a biasing component attached to the first end of the hinge body to selectively influence the resting angle of the hinge body with respect to the first end block. Various biasing components are within the spirit and scope of the invention. Further, as shown in FIGS. 1-4, 10-11, 15, the hinge apparatus may have the following additional components: a second end block attached to a second end of the hinge body and pivotal therewith around a second axis, and a second biasing component attached to the second end of the hinge body to selectively influence the resting angle of the hinge body with respect to the second end block.

As shown in FIGS. 1-4, the biasing component may comprise a cam roller attached to the hinge body, the cam roller having hills and valleys and a cam mounting plate attached to the first end block, the cam mounting plate positioned to ride on the cam roller such that the cam plate's hills and valley cause the first end block to rise and fall and seek a selected position.

As shown in FIGS. 1 and 4, the cam biasing component may further comprise a mounting plate on which the cam is positioned. The mounting plate has a plurality of holes and the hinge body has a locking hole. A locking pin is disposed through the cam, such that when the locking pin is inserted into one of the holes in the mounting plate the relative angular position of the first end block and the hinge is fixed. In a particular embodiment the locking pin is spring loaded.

FIG. 5 shows another biasing component. In this illustrative embodiment of the invention the biasing component comprises an offset pivot pin disposed on the first end block. A hinge pivot pin is pivotally connecting the first end to the hinge body. A resilient component having a first end and a second end is provided. The first end is attached to the offset pivot pin and the second end is attached to the hinge pivot pin to bias the hinge body to a selected position.

The hinge apparatuses of the invention can be functionally connected to a support arm, such as the arm shown in FIG. 9, which has two parallelogram-shaped segments. In this illustrative embodiment of the invention, the two arm segments can be attached by a hinge apparatus having a biasing component between the hinge body and one arm segment or between the hinge body and each arm segment. If a biasing component is used at each end of the hinge, they may be the same or different type of biasing components. It is noted that the term “end block” when used in specification, including the claims, can mean the support equipment itself. In certain embodiments of the invention a support component, such as an arm may be functionally attached to the hinge body via an end block or may be functionally attached directly to the hinge body.

A single parallelogram segment may also make up a support arm, and be functionally attached to the hinge body.

FIGS. 10, 12-16 show a biasing component comprising a first resilient member having a first end and a second end, a first hinge body termination point disposed on the hinge body, a first resilient member termination disc attached to the first end block and pivotal around the first axis, and a plurality of offset attachment points disposed on the first resilient member termination disc. The resilient member termination points on the disc and the first hinge body termination point are on the same side of the hinge apparatus with respect to top and bottom. The first resilient member first end is attached to the first hinge body termination point and the first resilient member second end is attached to the first resilient member termination disc at an offset attachment point; thereby biasing the first end block with respect to the hinge body to a position wherein the first resilient member tension is minimized. It is also noted that a second resilient member termination disc can be employed at a second end of the hinge body of that end is also pivotally connected to an end block.

FIGS. 10 and 11 show the hinge apparatus with the second end block attached to a second end of the hinge body and pivotal therewith around a second axis. These figures depict a second biasing component having a second resilient member with a first end and a second end, a second end block termination point on the second end block and a second hinge body termination point on the hinge body on a side opposite to the first hinge body termination point with respect to top and bottom. The second end block termination point and the second hinge block termination point are on the same side of the hinge apparatus with respect to top and bottom. The second end block termination point is located further from the first hinge body termination point than the second axis as measured when the second end block and the hinge body are positioned 180° to one another. The distance between the second end block termination point and the second hinge body termination point decreases as the second end block is rotated with respect to the hinge body around the second axis as the apparatus is adjusted away from a position in which the hinge body and the second end block are at 180° to one another. The second resilient member first end is attached to the hinge body at the second hinge body termination point and the second resilient member second end is attached to the second end block at the second end block termination point, thereby biasing the position of the second end block with respect to the hinge body to a position wherein the second resilient member tension is minimized. In a preferred embodiment of the invention, the distance between the second end block termination point and the first hinge body termination point increases as the first end block is rotated with respect to the hinge body around the first axis a position in which the hinge body and the first end block are at 180° to one another.

The various biasing systems described herein and their equivalents can be used alone or in conjunction with one another. For example, a hinge body may be connected to a first end block using a biasing system and to a second end block using a different biasing system.

Embodiments of the invention also include methods in which hinges described herein are used to bias pivotally linked components.

Though the present invention is described with reference to the particular embodiments of the invention herein set forth, it is understood that the present disclosure is made only by way of example, and that numerous changes in the details of construction may be resorted to without departing from the spirit and scope of the invention. Accordingly, it is intended that the invention not be limited to the specific illustrative embodiments, but be interpreted within the full spirit and scope of the appended claims and their equivalents.

Claimed is:

1. A hinge apparatus comprising:
a hinge body;
a first end block attached to a first end of the hinge body and pivotal therewith around a first axis;
a biasing component having a first termination point and a second termination point;
wherein the first termination point is at the first end block to selectively influence the resting angle of the hinge body with respect to the first end block.

2. The hinge apparatus of claim 1 wherein the second termination point of the biasing component is attached to the hinge body.

3. The hinge apparatus of claim 1 further comprising:
a second end block attached to a second end of the hinge body and pivotal therewith around a second axis;
wherein the second termination point of the biasing component is attached to the second end block.

4. The hinge apparatus of claim 1 further comprising:
a second end block attached to a second end of the hinge body and pivotal therewith around a second axis; and
a second biasing component attached to the second end block;
to selectively influence the resting angle of the hinge body with respect to the second end block.

5. The hinge apparatus of claim 1 wherein the biasing component comprises:
a cam roller attached to the hinge body, the cam roller having hills and valleys;
a cam mounting plate attached to the first end block, the cam mounting plate positioned to ride on the cam roller such that the cam plate's hills and valley cause the first end block to rise and fall and seek a selected position.

6. The hinge apparatus of claim 5 further comprising:
the cam positioned on a mounting plate;
the mounting plate having a plurality of holes;
the hinge body having a locking hole;
a locking pin disposed through the cam;
wherein when the locking pin is inserted into one of the holes in the mounting plate the relative angular position of the first end block and the hinge is fixed.

7. The hinge apparatus of claim 6 wherein the locking pin is spring loaded.

8. The hinge apparatus of claim 2 wherein the biasing component comprises:
an offset pivot pin disposed on the first end block;
a hinge pivot pin pivotally connecting the first end to the hinge body;
a resilient component having a first end and a second end, the first end attached to the offset pivot pin and the second end attached to the hinge pivot pin to bias the hinge body to a selected position.

9. The hinge apparatus of claim 1 further comprising:
at least one parallelogram support structure, wherein the hinge is functionally connected to the at least one parallelogram support structure.

10. The hinge apparatus of claim 1 wherein the biasing component comprises:
a first resilient member having a first end and a second end;
a first hinge body termination point disposed on the hinge body;
a first resilient member termination disc attached to the first end block and pivotal around the first axis;
a plurality of offset attachment points disposed on the first resilient member termination disc;
wherein the resilient member termination points on the disc and the first hinge body termination point are on the same side of the hinge apparatus with respect to top and bottom;
the first resilient member first end is attached to the first hinge body termination point and the first resilient member second end is attached to the first resilient member termination disc at an offset attachment point;
thereby biasing the first end block with respect to the hinge body to a position wherein the first resilient member tension is minimized.

11. The hinge apparatus of claim 10 wherein the plurality of offset attachment points are disposed on the first resilient member termination disc in an arc, each at substantially the same distance from the first axis.

12. The hinge apparatus of claim 10 wherein the plurality of offset attachment points are disposed on the first resilient member termination disc at varying distances from the first axis.

13. The hinge apparatus of claim 2 further comprising:
a second end block attached to a second end of the hinge body and pivotal therewith around a second axis;
a second biasing component;
the second biasing component comprising:
a second resilient member having a first end and a second end;
a second end block termination point on the second end block;
a second hinge body termination point on the hinge body;
wherein the second end block termination point and the second hinge block termination point are on the same side of the hinge apparatus with respect to top and bottom;
wherein the second end block termination point is located further from the first hinge body termination point than the second axis as measured when the second end block and the hinge body are positioned 180° to one another;
wherein the distance between the second end block termination point and the second hinge body termination point decreases as the second end block is rotated with respect to the hinge body around the second axis as the apparatus is adjusted away from a position in which the hinge body and the second end block are at 180° to one another;
wherein the second resilient member first end is attached to the hinge body at the second hinge body termination point and the second resilient member second end is attached to the second end block at the second end block termination point, thereby biasing the position of the second end block with respect to the hinge body to a position wherein the second resilient member tension is minimized.

14. The hinge apparatus of claim 13 wherein the distance between the second end block termination point and the first hinge body termination point increases as the first end block is rotated with respect to the hinge body around the first axis a position in which the hinge body and the first end block are at 180° to one another.

15. The hinge apparatus of claim 13 further comprising:
a resilient member tension adjusting mechanism disposed on the hinge body to adjust the tension in the second resilient member to accommodate different payloads supported by the end blocks.

16. The hinge apparatus of claim 15 further comprising:
a recess in the hinge body;
a plate slidably positioned within the recess;
the first hinge body termination point attachment component disposed on the plate; and
a locking mechanism to lock the plate in place with respect to the hinge body.

17. The hinge apparatus of claim 1 further comprising:
a second end block attached to a second end of the hinge body and pivotal therewith around a second axis;
a second resilient member termination disc attached to the second end block and pivotal around the second axis;
a plurality of offset attachment points disposed on the second resilient member termination disc;
wherein the first resilient member termination points on the first disc and the second resilient member termination points on the second disc are on the same side of the hinge apparatus with respect to top and bottom;
the first resilient member first end is attached to the first resilient member termination disc at an offset attachment point; and
the first resilient member second end is attached to the second resilient member termination disc at an offset attachment point;
thereby biasing the first end block with respect to the second end block to a position wherein the first resilient member tension is minimized.

18. The hinge apparatus of claim 1 further comprising:
a second end block attached to a second end of the hinge body and pivotal therewith around a second axis;
a compression gas spring component having a first end and a second end;
the gas spring first end attached at the first end block, displaced from the first axis;
the gas spring second end attached at the second end block, and displaced from the second axis; and
wherein the gas spring end block attachment points are on the same side of the hinge apparatus with respect to top and bottom;
thereby biasing the position of the first end block with respect to the second end block to a position wherein the gas spring tension is minimized.

19. The hinge apparatus of claim 1 wherein the biasing component is a compression spring.

20. The hinge apparatus of claim 1 wherein the biasing component is a resilient member.

21. The hinge apparatus of claim 1 wherein at least one biasing component termination point is on an offset bracket.

22. A method of biasing a hinge comprising:
providing a hinge body;
providing a first end block pivotally attached to a first end of the hinge body by a first axis;
biasing the hinge apparatus by attaching a biasing component to the first end block to selectively influence the resting angle of the hinge body with respect to the first end block.

23. The method of claim 22 wherein the second termination point of the biasing component is attached to the hinge body.

24. The method of claim 22 further comprising:
providing a second end block attached to a second end of the hinge body and pivotal therewith around a second axis;
wherein the second termination point of the biasing component is attached to the second end block.

25. The method of claim 22 wherein the biasing component comprises:
a cam roller attached to the hinge body, the cam roller having hills and valleys; and
a cam mounting plate attached to the first end block, the cam mounting plate positioned to ride on the cam roller such that the cam plate's hills and valley cause the first end block to rise and fall and seek a selected position.

26. The method of claim 22 wherein the biasing component comprises:
providing a resilient component attached to the hinge body and further attached to the first end block;
wherein the resilient member is attached to the end block at a location offset from the first axis.

27. The method of claim 22 wherein the biasing component comprises:
a first resilient member having a first end and a second end;
a first hinge body termination point disposed on the hinge body;
a first resilient member termination disc attached to the first end block and pivotal around the first axis;
a plurality of offset attachment points disposed on the first resilient member termination disc;
wherein the resilient member termination points on the disc and the first hinge body termination point are on the same side of the hinge apparatus with respect to top and bottom;
the first resilient member first end is attached to the first hinge body termination point and the first resilient member second end is attached to the first resilient member termination disc at an offset attachment point;
thereby biasing the first end block with respect to the hinge body to a position wherein the first resilient member tension is minimized.

28. The method of claim 23 further comprising:
providing a second end block attached to a second end of the hinge body and pivotal therewith around a second axis; and
providing a second biasing component, wherein the biasing component comprises:
a second resilient member having a first end and a second end;
a second end block termination point on the second end block;
providing a second hinge body termination point on the hinge body;
wherein the second end block termination point and the second hinge block termination point are on the same side of the hinge apparatus with respect to top and bottom;
wherein the second end block termination point is located further from the first hinge body termination point than the second axis as measured when the second end block and the hinge body are positioned 180° to one another;
wherein the distance between the second end block termination point and the second hinge body termination point decreases as the second end block is rotated with respect to the hinge body around the second axis as the apparatus is adjusted away from a position in which the hinge body and the second end block are at 180° to one another;
wherein the second resilient member first end is attached to the hinge body at the second hinge body termination point and the second resilient member second end is attached to the second end block at the second end block termination point, thereby biasing the position of the second end block with respect to the hinge body to a position wherein the second resilient member tension is minimized.

29. The method of claim 27 further comprising:
providing a second end block attached to a second end of the hinge body and pivotal therewith around a second axis;
providing a second biasing component, wherein the second biasing component comprises:
a second resilient member termination disc attached to the second end block and pivotal around the second axis;
a plurality of offset attachment points disposed on the second resilient member termination disc;
wherein the first resilient member termination points on the first disc and the second resilient member termination points on the second disc are on the same side of the hinge apparatus with respect to top and bottom;
the first resilient member first end is attached to the first resilient member termination disc at an offset attachment point; and
the first resilient member second end is attached to the second resilient member termination disc at an offset attachment point;
thereby biasing the first end block with respect to the second end block to a position wherein the first resilient member tension is minimized.

30. The method of claim 18 wherein the biasing component comprises:
providing a second end block attached to a second end of the hinge body and pivotal therewith around a second axis;
biasing the hinge with respect to the end blocks by employing a compression gas spring component attached at the first end block, displaced from the first axis, and attached at the second end block, and displaced from the second axis;
wherein the gas spring end block attachment points are on the same side of the hinge apparatus with respect to top and bottom;
thereby biasing the position of the first and second end blocks with respect to the second end block to a position wherein the gas spring tension is minimized.

31. The method of claim 22 comprising:
biasing the hinge apparatus using a compression spring.

32. The method of claim 22 comprising:
biasing the hinge apparatus using a resilient member.

33. A method of supporting equipment comprising:
providing at least one parallelogram support structure;
providing at least one hinge functionally connected to the parallelogram;
biasing the hinge to selectively influence the resting angle of the hinge relative to the parallelogram support structure.

34. A method of supporting equipment comprising:
providing a first support structure and a second support structure;
providing at least one hinge having a first end and a second end, wherein the first end is attached to the first support structure and the second end is attached to the second support structure;
biasing the support structures to selectively influence the resting angle of the first support structure with respect to the second support structure.
